(19) United States
(12) Patent Application Publication
(10) Pub. No.: US 2026/0279878 A1
(43) Pub. Date: Sep. 17, 2026

(54) BATTERY CELL FOLDING APPARATUS AND BATTERY CELL MANUFACTURING METHOD USING THE SAME

(71) Applicant: SK On Co., Ltd., Seoul (KR)

(72) Inventors: Ju Hwan LEE, Daejeon (KR); Joo Hyung KIM, Daejeon (KR); Hyung Joon KIM, Daejeon (KR); Hwan Cheol YOU, Daejeon (KR); Yong Ki CHOI, Daejeon (KR)

(21) Appl. No.: 19/565,513

(22) Filed: Mar. 13, 2026

(30) Foreign Application Priority Data
Mar. 13, 2025 (KR) 10-2025-0032460

(51) Int. Cl. H01M 10/04; H01M 50/105

(52) U.S. Cl. CPC H01M 10/0404; H01M 50/105

(57) ABSTRACT

A battery cell folding apparatus includes: a heating unit applying heat to a folding region where a sealing portion of a battery cell is folded at a first angle; a cell transport unit transporting the battery cell positioned at the heating unit to a subsequent process device; and a folding unit disposed on a path along which the battery cell moves from the heating unit to the subsequent process device and folding the folding region of the battery cell moving to the subsequent process device at a second angle.

### CROSS-REFERENCE TO RELATED APPLICATIONS

This application claims benefit of priority to Korean Patent Application No. 10-2025-0032460 filed on March 13, 2025 in the Korean Intellectual Property Office, the disclosure of which is incorporated herein by reference in its entirety.

### BACKGROUND

### 1. Field

The present disclosure relates to a folding apparatus for folding a sealing portion of a pouch-type battery cell and a battery cell manufacturing method using the same.

### 2. Description of Related Art

Unlike primary batteries, secondary batteries may be charged and discharged and may thus be applicable to a wide range of applications, including digital cameras, mobile phones, laptops, hybrid vehicles, and electric vehicles. Examples of the secondary batteries include nickel-cadmium batteries, nickel-metal hydride batteries, nickel-hydrogen batteries, and lithium secondary batteries.

Among such secondary batteries, many studies have been conducted on lithium secondary batteries having high energy density and discharge voltage. Recently, lithium secondary batteries have been manufactured as flexible pouch-type battery cells or rigid square or cylindrical can type battery cells.

Among such batteries, in a pouch-type battery cell, a space is formed in a film casing to accommodate an electrode assembly, and a sealing portion is formed by sealing at least a portion of the periphery of the electrode assembly. The electrode assembly is connected to an electrode lead, and the electrode lead is exposed to the outside through the sealing portion. The sealing portion, where the electrode lead is not positioned, is folded to enhance sealing reliability and minimize the volume occupied by the sealing portion.

### SUMMARY

An aspect of the present disclosure is to rapidly fold a sealing portion of a pouch-type battery cell, thereby reducing a battery cell manufacturing time.

The battery cell manufactured through the present disclosure may be widely applied in an electric vehicle, a battery charging station, and other green technology fields such as solar power generation and wind power generation using batteries. Furthermore, the battery cell manufactured through the present disclosure may be used in an eco-friendly electric vehicle, a hybrid vehicle, and the like that aim to prevent climate change by reducing air pollution and greenhouse gas emissions.

According to an aspect of the present disclosure, a battery cell folding apparatus includes: a heating unit applying heat to a folding region where a sealing portion of a battery cell is folded at a first angle; a cell transport unit transporting the battery cell positioned at the heating unit to a subsequent process device; and a folding unit disposed on a path along which the battery cell moves from the heating unit to the subsequent process device and folding the folding region of the battery cell moving to the subsequent process device at a second angle.

The folding unit may include a plurality of rollers sequentially pressing the folding region, a first roller disposed closest to the heating unit among the plurality of rollers may fold the folding region at an obtuse folding angle, and an n-th roller disposed farthest from the heating unit among the plurality of rollers may fold the folding region at an acute folding angle.

At least one of the plurality of rollers may fold the folding region at a right angle.

The heating unit may include a heating block heating and pressing the folding region in a state in which the folding region is folded at the first angle.

The subsequent process device may include the pressing unit pressing the folding region of the battery cell, and the pressing unit may include at least one pressing roller pressing the folding region such that the folding region is folded at a third angle.

The pressing roller may reciprocate along the sealing portion and press the folding region.

The plurality of rollers may each have a cylindrical shape and be arranged with different rotational axes.

The plurality of rollers may have parallel rotational axes and different outer peripheral surfaces.

The folding unit may be formed as a block having a folding groove through which the sealing portion is inserted and passes, and the folding groove may be formed by partially cutting one surface of the block that faces the battery cell in a movement direction of the battery cell.

In the folding groove, shapes of an inlet through which the sealing portion is inserted and an outlet through which the sealing portion exits the folding groove may be different from each other.

The sealing portion may be inserted into the folding groove in a state in which a folding angle of the folding region is an obtuse angle, and the sealing portion may exit the folding groove in a state in which the folding angle is an acute angle.

The inlet of the folding groove may be larger than the outlet of the folding groove.

According to another aspect of the present disclosure, a battery cell manufacturing method includes: applying heat to a folding region where a sealing portion of a battery cell is folded at a first angle; and folding the folding region of the battery cell at a second angle smaller than the first angle while transporting the battery cell to a subsequent process.

The battery cell manufacturing method may further include, after the folding of the folding region at the second angle, pressing the folding region of the battery cell to maintain a third angle.

The folding of the folding region at the second angle may include gradually folding the folding region so as to have the second angle by using a plurality of rollers that sequentially press the folding region.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic view illustrating a shape of a pouch-type battery cell before folding;

FIG. 2 is a schematic view sequentially illustrating an example of a change in a shape of a sealing portion of the pouch-type battery cell illustrated in FIG. 1 taken along line I-I' of FIG. 1 during folding;

FIG. 3 is a perspective view schematically illustrating a battery cell folding apparatus according to the present exemplary embodiment;

FIG. 4 is a cross-sectional view taken along line A-A' of FIG. 3;

FIG. 5 is a plan view of a folding unit illustrated in FIG. 3;

FIG. 6 is a cross-sectional view taken along line B-B' of FIG. 3;

FIG. 7 is a cross-sectional view taken along line C-C' of FIG. 3;

FIG. 8 is a flowchart illustrating a manufacturing method using the battery cell folding apparatus illustrated in FIG. 3;

FIG. 9 is a cross-sectional view illustrating a folding unit according to another exemplary embodiment in the present disclosure;

FIG. 10 is a perspective view illustrating a battery cell folding apparatus according to still another exemplary embodiment in the present disclosure; and

FIG. 11 is a partial cross-sectional view of a folding unit illustrated in FIG. 10.

### DETAILED DESCRIPTION

Hereinafter, the present disclosure will be described in detail with reference to the accompanying drawings. However, the description is merely exemplary and the present disclosure is not limited to specific exemplary embodiments illustrated by way of example.

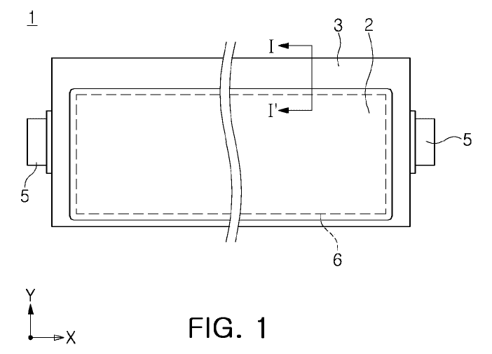

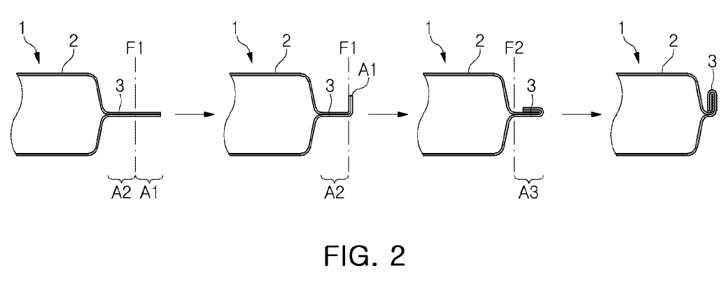

First, a pouch-type battery cell 1 manufactured through the present disclosure will be described with reference to FIGS. 1 and 2.

FIG. 1 is a schematic view illustrating a shape of the pouch-type battery cell before folding, and FIG. 2 is an explanatory view sequentially illustrating an example of a change in a shape of a sealing portion of the pouch-type battery cell illustrated in FIG. 1 taken along line I-I' of FIG. 1 during folding of the sealing portion.

Referring to FIGS. 1 and 2, the pouch-type battery cell 1 may include a cell body 2 accommodating an electrode assembly 6 therein, and a sealing portion 3 formed by sealing at least a part of the periphery of the cell body 2 to isolate the electrode assembly 6 from the outside. The sealing portion 3 may be formed at a flange-shaped exposed portion on an outer side of the cell body 2. An electrode lead 5 may be connected to the electrode assembly 6, and the electrode lead 5 may have a shape exposed to the outside through a part of the sealing portion 3.

FIG. 1 illustrates an example of the pouch-type battery cell 1 in which a single film casing is folded to form the cell body 2 and the sealing portion 3. In this case, the sealing portion 3 may be formed on each of three sides (an upper side and left and right sides of the cell body 2 in FIG. 1) of the cell body 2.

However, a structure of the sealing portion 3 of the pouch-type battery cell 1 applied to the present disclosure is not limited thereto. For example, in the pouch-type battery cell 1, the cell body 2 and the sealing portion 3 may be formed by bonding two film casings, and in this case, the sealing portion 3 may be formed on each of four sides of the cell body 2.

The sealing portion 3 may be folded to increase bonding reliability of a sealed portion and significantly reduce a volume occupied by the sealing portion 3. In other words, at least some of a plurality of sealing portions 3 may be folded at least once. For example, the sealing portion 3 positioned at a portion where the electrode lead 5 is not disposed may have a shape folded at least once.

Referring to FIG. 2, the sealing portion 3 of the pouch-type battery cell 1 is folded at least once and has a folded structure folded at a specific angle. For example, when a sealing portion state (hereinafter, referred to as an initial state) before folding is defined as 0 degrees, an outer region A1 (hereinafter, referred to as a first folding region) of the sealing portion 3 may be folded by approximately 90 degrees based on a first folding line F1 in a first folding process, and the first folding region A1 may be folded again by 90 degrees in a second folding process. Therefore, after the second folding process is completed, the first folding region A1 may be folded by 180 degrees based on the initial state of the sealing portion 3.

Further, in a third folding process, an outer region A3 (hereinafter, referred to as a third folding region) of the sealing portion 3 may be additionally folded by 90 degrees based on a second folding line F2. In this case, the first folding region A1 may be folded by 270 degrees based on the initial state of the sealing portion 3, and ultimately, the first folding region A1 of the sealing portion 3 may be positioned adjacent to a side wall of the cell body 2.

In the present exemplary embodiment, the folding of the sealing portion 3 may correspond to any one of the first to third folding processes described above. However, in the exemplary embodiments of the present disclosure, the folding of the sealing portion 3 is not limited to a process of folding the sealing portion 3 at a specific angle such as 90 degrees, 180 degrees, or 270 degrees. Furthermore, the number of folding processes may be variously changed to one or more.

In this way, setting of a folding angle for the sealing portion 3 and the number of folding processes may be changed depending on final specifications of the battery cell 1. In addition, the folding process for the sealing portion 3 may be performed using a folding apparatus 10 described below.

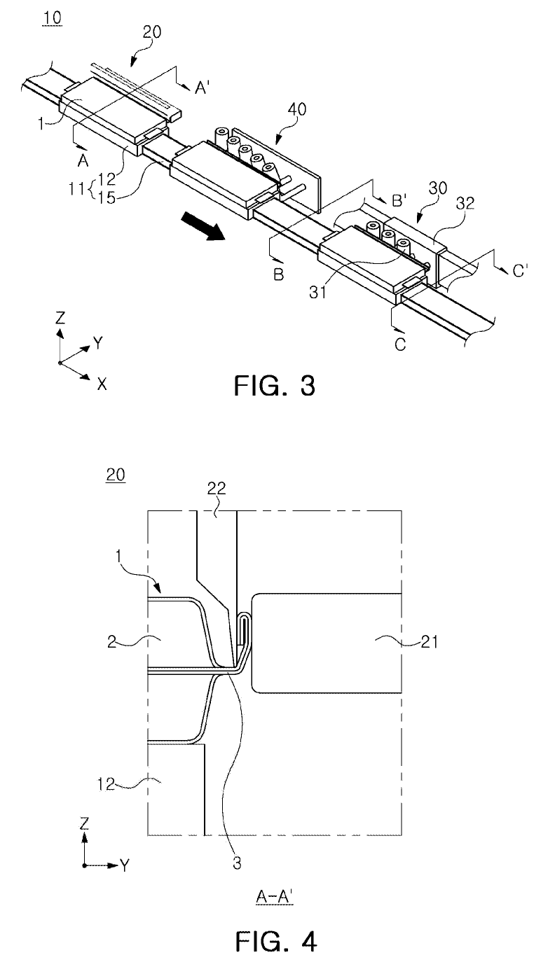

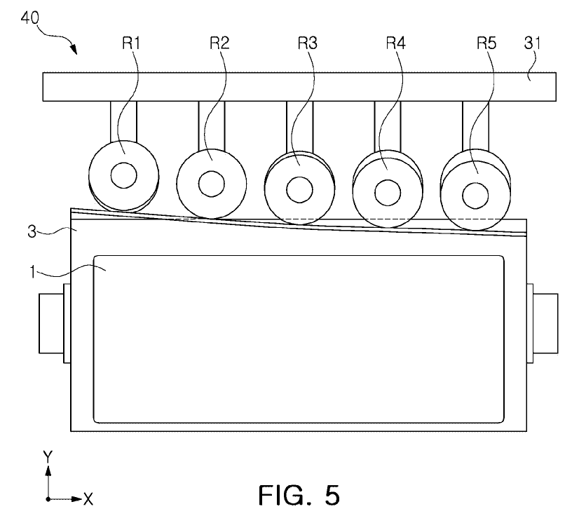

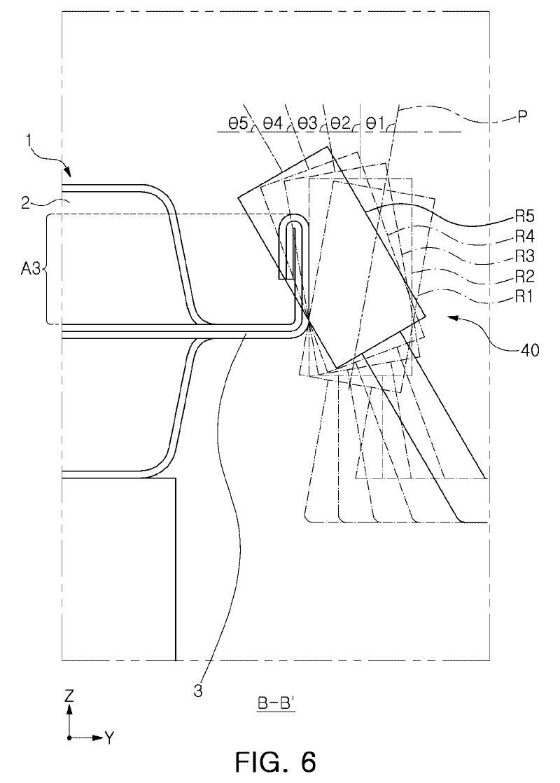

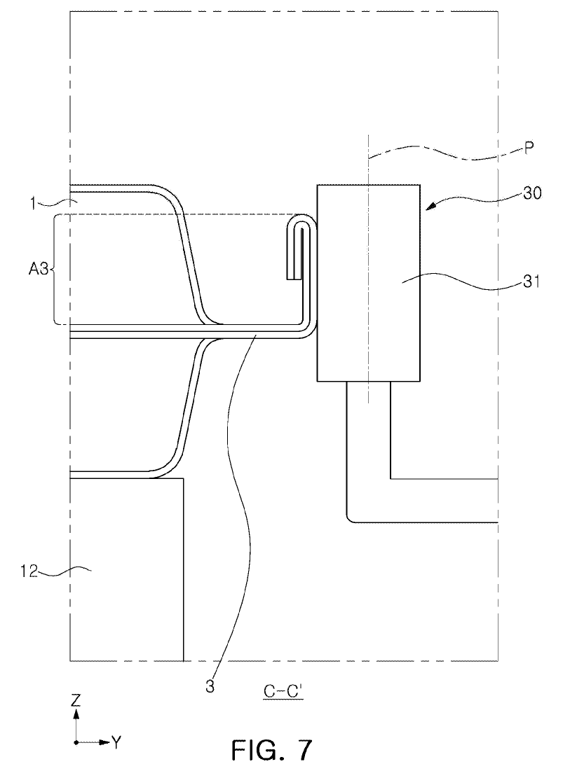

FIG. 3 is a perspective view schematically illustrating a battery cell folding apparatus according to the present exemplary embodiment. FIG. 4 is a cross-sectional view taken along line A-A' of FIG. 3, FIG. 5 is a plan view of a folding unit illustrated in FIG. 3, FIG. 6 is a cross-sectional view taken along line B-B' of FIG. 3, and FIG. 7 is a cross-sectional view taken along line C-C' of FIG. 3.

Referring to FIGS. 3 through 7, the battery cell folding apparatus 10 according to the present exemplary embodiment may include a heating unit 20 applying heat to a folding region of the battery cell 1 where the sealing portion 3 is folded at a first angle, a cell transport unit transporting the battery cell 1 positioned at the heating unit 20 to a subsequent process device, and a folding unit 40 disposed on a path along which the battery cell 1 moves from the heating unit 20 to the subsequent process device and folding the folding region of the battery cell 1 moving to the subsequent process device at a second angle. Here, the subsequent process device may be a pressing unit 30 that presses the folding region of the battery cell 1.

In the following description, a first direction may refer to a thickness direction of the battery cell 1 (a Z-axis direction or an up-down direction in FIG. 3), a second direction may refer to a direction in which the sealing portion 3 protrudes from the cell body 2 of the battery cell 1, that is, a surface direction or width direction of the battery cell 1 (a Y-axis direction in FIG. 3). A third direction may refer to a length direction of the battery cell 1 (an X-axis direction or a left-right direction in FIG. 3). Furthermore, the first to third directions may each include both positive (+) and negative (-) directions.

In the following description, the “folding angle” may refer to an angle at which the third folding region A3 is folded. Specifically, the “folding angle” may refer to the initial state of the sealing portion 3 in FIG. 2 or an angle between the second direction and the third folding region A3.

The cell transport unit 11 may transport the battery cell 1. The cell transport unit 11 may sequentially position the battery cell 1 in the heating unit 20 and the pressing unit 30 which is a subsequent process device to the heating unit 20, and during the process, the battery cell 1 may pass through the folding unit 40. To this end, the cell transport unit 11 may include a mounting portion 12 on which the battery cell 1 is mounted, and a rail 15 to and along which the mounting portion 12 is coupled and moves.

The mounting portion 12 may be a portion on which the battery cell 1 is mounted during the folding of the sealing portion 3 of the battery cell 1, and may have a flat surface supporting a lower surface of the battery cell 1. When the battery cell 1 is mounted on the mounting portion 12, the sealing portion 3 of the battery cell 1 may protrude outward from the mounting portion 12. Therefore, the mounting portion 12 may not be positioned in a region facing the sealing portion 3 of the battery cell 1.

In the following description, a position of each component is based on the battery cell 1 mounted on the mounting portion 12. Therefore, unless otherwise specified, the battery cell 1 referred to in the following description may refer to the battery cell 1 mounted on the mounting portion 12 as illustrated in FIG. 3.

The folding process may be performed in a state in which the battery cell 1 is fixed to the mounting portion 12. To this end, the mounting portion 12 may include a suction device that vacuum-sucks the battery cell 1 or a pressing device that presses the battery cell 1 from above.

The rail 15 may be positioned along the path along which the mounting portion 12 moves, and the mounting portion 12 may be coupled to the rail 15 so as to be slidable along the rail 15.

Meanwhile, the present exemplary embodiment is not limited thereto, and various modifications are possible as long as the mounting portion 12 may move along a set path.

The folding apparatus 10 of the present exemplary embodiment may perform the third folding process described above. For example, as illustrated in FIG. 4, the heating unit 20 may include a heating block 21 that applies heat and pressure to the folding region in a state in which the third folding region is folded at the first angle. Here, the first angle may be approximately 90°. Accordingly, the third folding region (A3 in FIG. 2) of the battery cell 1 transported to the heating unit 20 by the cell transport unit 11 may be in a state of being folded at the first angle.

The heating unit 20 may include the heating block 21 and a support frame 22, and may apply heat to the third folding region A3 folded at the first angle and the second folding line F2 through the heating block 21. During the process, the heating block 21 may pressurize the third folding region A3 toward the cell body 2. Further, the support frame 22 may be positioned to face the heating block 21 with the third folding region A3 interposed therebetween. Accordingly, the third folding region A3 may be thermally pressed by the support frame 22 and the heating block 21.

The heating block 21 may apply heat to the sealing portion 3 of the battery cell 1 positioned at the heating unit 20 for a certain period of time. Therefore, the sealing portion 3 of the battery cell 1 transported from the heating unit 20 to the folding portion 40 may be in a state of being heated by the heating block 21.

The folding unit 40 may be positioned between the heating unit 20 and the pressing unit 30. Therefore, the cell transport unit 11 may pass through the folding unit 40 while moving to the pressing unit 30.

As illustrated in FIGS. 5 and 6, the folding unit 40 may include a plurality of rollers R1 to R5 that sequentially pressurize the folding region. Among the plurality of rollers R, a first roller, which is disposed closest to the heating unit 20, may fold the third folding region A3 at an obtuse folding angle, and among the plurality of rollers R, an n-th roller, which is disposed farthest from the heating unit 20, may fold the third folding region A3 at an acute folding angle. Here, n may be a natural number.

Furthermore, at least one of the plurality of rollers R1 to R5 may fold the third folding region A3 at a right angle.

The folding unit 40 may pressurize the third folding region A3 in the second direction (Y-axis direction) toward the cell body 2 through the plurality of rollers R1 to R5. Accordingly, the third folding region A3 of the battery cell 1 may be pressed to finally form the second angle while passing through the folding unit 40. Here, the second angle may be different from the first angle, for example, an acute angle.

The plurality of rollers R1 to R5 may be arranged in a row in the third direction, which is a path along which the battery cell 1 moves. Furthermore, the plurality of rollers R1 to R5 may each have a cylindrical shape and may be arranged with different rotational axes P.

In an exemplary embodiment, the plurality of rollers R1 to R5 may be arranged such that an intersection angle between the rotational axis P and the second direction (Y-axis direction) decreases as a distance to the pressing unit 30 decreases. Accordingly, the folding angle of the third folding region A3 pressed by the rollers R1 to R5 may also decrease as the distance to the pressing unit 30 decreases.

Furthermore, in an exemplary embodiment, the intersection angle of at least one of the rollers R1 to R5 may be an acute angle, and the intersection angle of at least one of the rollers R1 to R5 may be an obtuse angle. In addition, the intersection angle of at least one of the rollers R1 to R5 may be a right angle.

The folding unit 40 according to the present exemplary embodiment may include the first to fifth rollers R1 to R5. The first to fifth rollers R1 to R5 may be sequentially arranged in the third direction, and thus, the first roller R1 may be disposed closest to the heating unit 20 among the plurality of rollers R1 to R5. In addition, the fifth roller R5 may be disposed closest to the pressing unit 30 among the plurality of rollers R1 to R5.

The intersection angles of the rollers R1 to R5 may be 100°, 90°, 80°, 70°, and 60°, respectively. Specifically, an intersection angle θ1 of the first roller R1 may be 100°, an intersection angle θ2 of the second roller R2 may be 90°, an intersection angle θ3 of the third roller R3 may be 80°, an intersection angle θ4 of the fourth roller R4 may be 70°, and an intersection angle θ5 of the fifth roller R5 may be 60°. However, the configuration of the present exemplary embodiment is not limited thereto.

The third folding region A3 of the battery cell 1 is pressed in the heating unit 20. However, when the battery cell 1 leaves the heating unit 20 and moves toward the pressing unit 30, the third folding region A3 may be partially unfolded due to a spring back phenomenon. Therefore, the third folding region A3 of the battery cell 1 moving from the heating unit 20 toward the pressing unit 30 is difficult to maintain an angle of 90° with respect to the second direction.

In this regard, the first roller R1 of the folding unit 40 may be disposed to form the intersection angle θ1 of 100°. Accordingly, even in a case where the third folding region A3 rotates away from the cell body 2 due to the spring back phenomenon, the first roller R1 may support the third folding region A3.

Furthermore, since the battery cell 1 passes through the folding unit 40 in a state in which the sealing portion 3 is heated by the heating unit 20, the heated sealing portion 3 is maintained at a certain temperature at the folding unit 40, so that the third folding region A3 may be folded. Further, since the battery cell 1 exits the folding unit 40 in a state in which an intersection angle between the third folding region A3 and the second direction is an acute angle, even in a case where the spring back phenomenon occurs in the third folding region A3 after the battery cell 1 passes through the folding unit 40, the third folding region A3 may maintain an angle of approximately 90° with respect to the second direction.

The pressing unit 30 may additionally press the third folding region A3. To this end, the pressing unit 30 may include at least one pressing roller 31 that presses the third folding region A3 such that the third folding region A3 is folded at a third angle.

Here, the third angle may be different from the second angle. Furthermore, the third angle may be substantially equal to the first angle, or may be greater than the second angle and close to the first angle.

The pressing roller 31 may reciprocate along the sealing portion 3 and press the third folding region A3. To this end, the pressing roller 31 may be connected to a movement device 32 that reciprocates the pressing roller 31 in the third direction. The movement device 32 may be any known device capable of linearly reciprocating the pressing roller 31 in the third direction, such as a linear motor, a hydraulic/pneumatic cylinder, or a robot arm.

The pressing roller 31 may be disposed with a rotational axis P parallel to the first direction (Z-axis direction). Therefore, the third folding region A3 and the second folding line F2 of the battery cell 1 entering the pressing unit 30 in a state in which the third folding region A3 is folded by approximately 90° with respect to the second direction (Y-axis direction) may be re-pressed by the pressing roller 31.

To this end, the pressing roller 31 may be formed longer than a width of the third folding region A3 and may come into contact with the entire third folding region A3 while reciprocating in the third direction through the movement device 32.

However, the present exemplary embodiment is not limited thereto. For example, the pressing roller 31 may be fixed and the battery cell 1 may reciprocate for pressing of the third folding region A3 and the second folding line F2.

Next, a manufacturing method using the folding apparatus 10 of the present exemplary embodiment will be described.

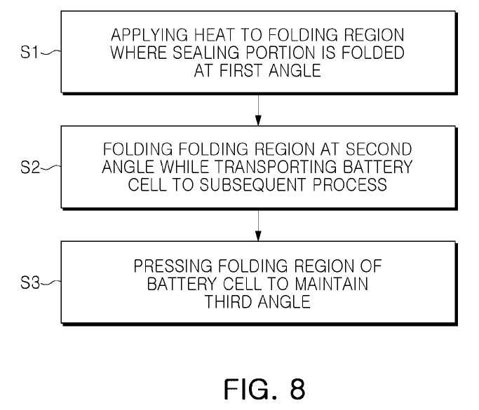

FIG. 8 is a flowchart illustrating a battery cell manufacturing method using the battery cell folding apparatus illustrated in FIG. 3.

Referring to FIG. 8, the battery cell manufacturing method of the present exemplary embodiment may include: applying heat to the third folding region A3 where the sealing portion of the battery cell is folded at the first angle (S1); and folding the third folding region A3 of the battery cell 1 at the second angle smaller than the first angle while transporting the battery cell 1 positioned at the heating unit 20 to a subsequent process (S2).

Furthermore, the battery cell manufacturing method of the present exemplary embodiment may further include, after the folding of the third folding region A3 at the second angle, pressing the third folding region A3 of the battery cell 1 to maintain the third angle (S3).

First, the cell transport unit 11 may enter the heating unit 20 in a state of fixing the battery cell 1. At this time, the battery cell 1 may be in a state in which the third folding region A3 of the sealing portion 3 is folded at the first angle.

When the battery cell 1 enters the heating unit 20, the heating unit 20 may perform heating of the third folding region A3 and the second folding line F2 using the heating block 21 (S1). The heating block 21 may move toward the battery cell 1 and come into surface contact with the third folding region A3, and the third folding region folded at the first angle may be heated by the heating block 21. During the process, the second folding line F2 may also be heated.

While the third folding region A3 is heated, the cell transport unit 11 may remain stationary.

Once heating is completed, the heating block 21 may move away from the battery cell 1, and the cell transport unit 11 may transport the battery cell 1 to the pressing unit 30. Since the heating unit 20 and the pressing unit 30 are spaced a certain distance apart, the cell transport unit 11 may move a certain distance to reach the pressing unit 30.

During the movement of the cell transport unit 11 to the pressing unit 30, the battery cell 1 may pass through the folding unit 40 positioned between the heating unit 20 and the pressing unit 30, and in the process, the third folding region A3 may be folded at the second angle (S2).

The folding of the third folding region A3 at the second angle (S2) may include gradually folding the third folding region A3 so as to have the second angle by using the plurality of rollers R1 to R5 that sequentially press the third folding region A3. Specifically, during the movement of the cell transport unit 11, the battery cell 1 may come into contact with the plurality of rollers R1 to R5 of the folding unit 40. Accordingly, the third folding region A3 of the battery cell 1 may sequentially come into contact with the first to fifth rollers R1 to R5 and be folded such that the intersection angle with respect to the second direction becomes the second angle. Here, the second angle may be an acute angle.

The battery cell 1 of the present exemplary embodiment may pass through the folding unit 40 before heat applied to the sealing portion 3 by the heating unit 20 is cooled. Therefore, even if the third folding region A3 partially returns due to the spring back phenomenon after passing through the folding unit 40, the above-described intersection angle may be maintained at approximately 90°.

The cell transport unit 11 that has passed through the folding unit 40 may enter the pressing unit 30. At this time, in the sealing portion 3 of the battery cell 1, the third folding region A3 may move in the opposite direction due to the spring back phenomenon, and the folding angle of the sealing portion 3 may become approximately the first angle.

When the battery cell 1 enters the pressing unit 30, the pressing roller 31 of the pressing unit 30 may move in the second direction, that is, a direction parallel to the second folding line F2, and press the third folding region A3 toward the cell body 2 (S3). In the pressing, the pressing roller 31 may support the third folding region A3 and press the third folding region A3 such that the folding angle of the third folding region A3 maintains the first angle. Therefore, through the pressing, the sealing portion 3 of the battery cell 1 may be fixed in a state in which the folding angle of the third folding region A3 is the third angle, which is approximately 90°.

Meanwhile, the cell transport unit 11 may remain stationary while the third folding region A3 is pressed by the pressing roller 31.

Thereafter, the cell transport unit 11 may transport the battery cell 1 to a subsequent process.

In the manufacturing method of the present exemplary embodiment described above, as the folding unit 40 is disposed between the heating unit 20 and the pressing unit 30, the sealing portion 3 of the battery cell 1 may be additionally pressed while the battery cell 1 moves from the heating unit 20 to the pressing unit 30. Therefore, the spring back phenomenon occurring in the sealing portion 3 of the battery cell 1 may be significantly reduced, thereby increasing a yield.

Hereinafter, exemplary embodiments of the present disclosure will be further described with reference to specific experimental examples. Examples and comparative examples included in the experimental examples are merely illustrative of the present disclosure and do not limit the scope of the appended claims. It will be apparent to those skilled in the art that various modifications and variations of the exemplary embodiments are possible within the scope and technical spirit of the present disclosure, and it is a matter of course that such modifications and variations fall within the scope of the appended claims.

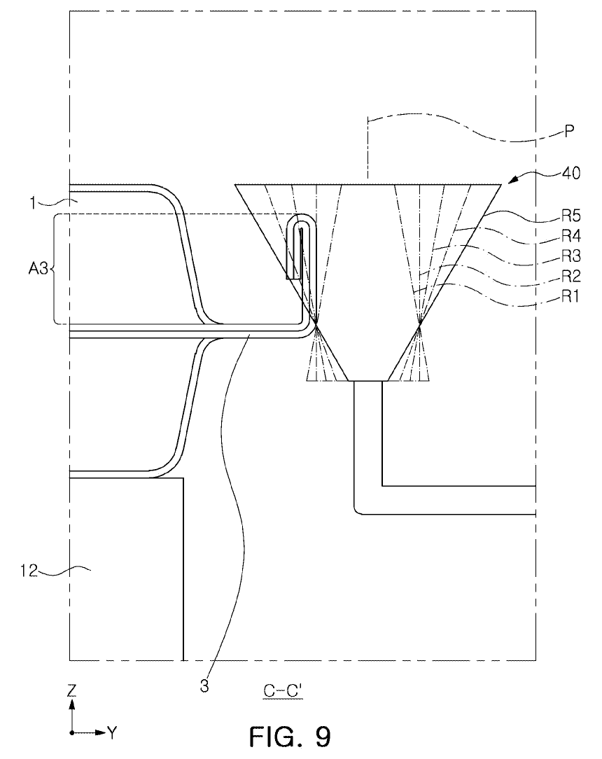

FIG. 9 is a cross-sectional view illustrating a folding unit according to another exemplary embodiment in the present disclosure taken along line C-C' of FIG. 3.

Referring to FIG. 9, a folding unit 40 of the present exemplary embodiment may include a plurality of rollers R1 to R5, similar to the above-described exemplary embodiment. However, in the present exemplary embodiment, the plurality of rollers R1 to R5 may have parallel rotation axes P and different outer peripheral surfaces.

The plurality of rollers R1 to R5 may be formed in shapes corresponding to a contact line where the rollers R1 to R5 of the above-described exemplary embodiment come into contact with a third folding region A3. Therefore, at least one of the rollers R1 to R5 of the present exemplary embodiment may have a different outer diameter depending on a direction of the rotational axis P.

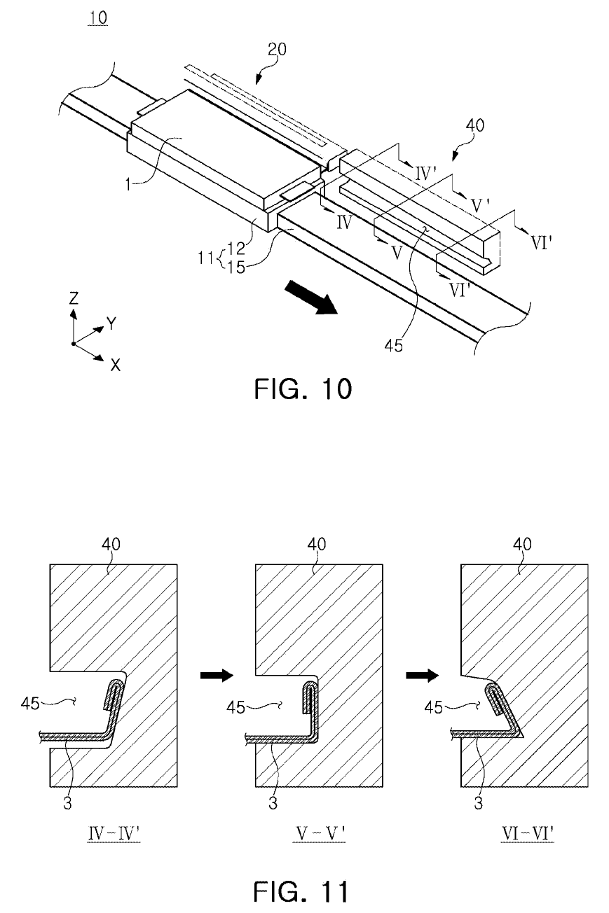

FIG. 10 is a perspective view illustrating a battery cell folding apparatus according to still another exemplary embodiment in the present disclosure, and FIG. 11 is a partial cross-sectional view of a folding unit illustrated in FIG. 10.

Referring to FIGS. 10 and 11, a battery cell folding apparatus 10 of the present exemplary embodiment may be formed similarly to the above-described exemplary embodiment except that the pressing unit 30 of the above-described exemplary embodiment is not provided. Accordingly, a subsequent process device in the present exemplary embodiment may be a process device operated after a battery cell 1 is folded.

Accordingly, the battery cell 1 positioned at a heating unit 20 may pass through a folding unit 40 while being transported to the subsequent process device. During the process, a sealing portion 3 of the battery cell 1 may be fixed such that the third folding region A3 is approximately orthogonal to a second direction.

Furthermore, in the battery cell folding apparatus 10 of the present exemplary embodiment, the folding unit 40 may be formed in a block shape.

The folding unit 40 of the present exemplary embodiment may be formed as a block having a folding groove 45 through which the sealing portion 3 is inserted and passes. The folding groove 45 may be formed by partially cutting one surface of the block that faces the battery cell 1 in a movement direction of the battery cell 1.

The folding unit 40 may be formed to extend in a third direction in which the battery cell 1 moves, and the folding groove 45 may be formed on one surface of the folding unit 40 that faces the battery cell 1 to accommodate and fold the sealing portion 3 of the battery cell 1.

The sealing portion 3 of the battery cell 1 may move while being inserted into the folding groove 45, and during the process, the third folding region A3 may be folded in accordance with a shape of the folding groove 45. To this end, the folding groove 45 may be formed as a groove formed by partially cutting the folding unit 40 in the movement direction of the battery cell 1 on one surface of the folding unit 40. Shapes of an inlet through which the sealing portion 3 is inserted into the folding groove 45 and an outlet through which the sealing portion 3 exits the folding groove 45 may be different from each other.

For example, an inlet portion (near an IV-IV’ cross section) of the folding groove 45 may be formed in a size and shape such that the sealing portion 3 of the battery cell 1 moving from the heating unit 20 may be easily inserted. In addition, an outlet (near a VI-VI’ cross section) of the folding groove 45 may be formed in a shape such that the third folding region A3 of the sealing portion 3 of the battery cell 1 forms an acute angle with respect to the second direction. Accordingly, the inlet of the folding groove 45 may be formed larger than the outlet of the folding groove 45.

As a result, the sealing portion 3 may be inserted into the folding groove 45 in a state in which a folding angle of the third folding region A3 is an obtuse angle, and may exit the folding groove 45 in a state in which the folding angle is an acute angle. For example, the sealing portion 3 of the battery cell 1 may be inserted into the inlet of the folding groove 45 and then move along the folding groove 45, so that the third folding region A3 gradually rotates to form an acute angle with respect to the second direction. Therefore, similar effects to the above-described exemplary embodiment may be achieved.

The folding unit 40 of the present exemplary embodiment may be formed as a single block, making manufacturing and management easy. However, the present exemplary embodiment is not limited thereto.

As set forth above, according to an exemplary embodiment in the present disclosure, a speed of folding the sealing portion of the pouch-type battery cell may be improved, thereby reducing a battery cell manufacturing time and increasing battery cell production.

While example embodiments have been shown and described above, it will be apparent to those skilled in the art that modifications and variations could be made without departing from the scope of the present invention as defined by the appended claims.

For example, the present disclosure may be practiced by omitting some components in the above-described exemplary embodiments, and the respective embodiments may be practiced in combination with each other.

What is claimed is:

1. A battery cell folding apparatus comprising:
a heating unit applying heat to a folding region where a sealing portion of a battery cell is folded at a first angle;
a cell transport unit transporting the battery cell positioned at the heating unit to a subsequent process device; and
a folding unit disposed on a path along which the battery cell moves from the heating unit to the subsequent process device and folding the folding region of the battery cell moving to the subsequent process device at a second angle.

2. The battery cell folding apparatus according to claim 1, wherein
the folding unit includes a plurality of rollers sequentially pressing the folding region,
a first roller disposed closest to the heating unit among the plurality of rollers folds the folding region at an obtuse folding angle, and
an n-th roller disposed farthest from the heating unit among the plurality of rollers folds the folding region at an acute folding angle.

3. The battery cell folding apparatus according to claim 2, wherein at least one of the plurality of rollers folds the folding region at a right angle.

4. The battery cell folding apparatus according to claim 1, wherein the heating unit includes a heating block heating and pressing the folding region in a state in which the folding region is folded at the first angle.

5. The battery cell folding apparatus according to claim 2, wherein
the subsequent process device includes the pressing unit pressing the folding region of the battery cell, and
the pressing unit includes at least one pressing roller pressing the folding region such that the folding region is folded at a third angle.

6. The battery cell folding apparatus according to claim 5, wherein the pressing roller reciprocates along the sealing portion and presses the folding region.

7. The battery cell folding apparatus according to claim 2, wherein the plurality of rollers each have a cylindrical shape and are arranged with different rotational axes.

8. The battery cell folding apparatus according to claim 2, wherein the plurality of rollers have parallel rotational axes and different outer peripheral surfaces.

9. The battery cell folding apparatus according to claim 1, wherein
the folding unit is formed as a block having a folding groove through which the sealing portion is inserted and passes, and
the folding groove is formed by partially cutting one surface of the block that faces the battery cell in a movement direction of the battery cell.

10. The battery cell folding apparatus according to claim 9, wherein in the folding groove, shapes of an inlet through which the sealing portion is inserted and an outlet through which the sealing portion exits the folding groove are different from each other.

11. The battery cell folding apparatus according to claim 9, wherein
the sealing portion is inserted into the folding groove in a state in which a folding angle of the folding region is an obtuse angle, and
the sealing portion exits the folding groove in a state in which the folding angle is an acute angle.

12. The battery cell folding apparatus according to claim 10, wherein the inlet of the folding groove is larger than the outlet of the folding groove.

13. A battery cell manufacturing method comprising:
applying heat to a folding region where a sealing portion of a battery cell is folded at a first angle; and
folding the folding region of the battery cell at a second angle smaller than the first angle while transporting the battery cell to a subsequent process.

14. The battery cell manufacturing method according to claim 13, further comprising, after the folding of the folding region at the second angle, pressing the folding region of the battery cell to maintain a third angle.

15. The battery cell manufacturing method according to claim 14, wherein the folding of the folding region at the second angle includes gradually folding the folding region so as to have the second angle by using a plurality of rollers that sequentially press the folding region.
